(19) United States
(12) Patent Application Publication
(10) Pub. No.: US 2010/0262731 A1
(43) Pub. Date: Oct. 14, 2010

(54) Integrated Access Cable

(76) Inventor: Hugo Lin, Taipei (TW)

Correspondence Address: GIBBONS P.C., ONE GATEWAY CENTER, NEWARK, NJ, 07102, US

(21) Appl. No.: 12/423,460

(22) Filed: Apr. 14, 2009

(51) Int. Cl. G06F 13/12

(52) U.S. Cl. 710/64

(57) ABSTRACT

An improved integrated access cable for a Keyboard, mouse and video (KVM) system which integrates the functions of the interface module for KVM interface into servers into a VGA connecter.

### BACKGROUND OF THE INVENTION

1. Field of the invention

The present invention relates to the use of data cables between keyboard, video and mouse (“KVM”) switches and computers. More specifically, the present invention relates to the disposition of the Interface Module between a particular computer and a KVM switch.

2. Description of Related Art

A keyboard, monitor and mouse, or “KVM” switch is a device that allows control and access multiple (2 or more) computers from just one (or more) console(s). A KVM switch provides direct access to the keyboard, video and mouse (KVM) ports of the controlled computers. KVM switches, depending on the model, may allow controlling two to thousands of computers, from one or any number of controlling consoles, locally or remotely. KVM switches are often found in data centers where many networked computers (called servers in this context) are arrayed in a single rack, and many racks are arrayed in a server room. Such servers, for reasons of expense and space, typically do not have their own KVM consoles, but still need to be configured, maintained, updated and occasionally rebooted. As KVM switches do not require any server side software installations, but are a hardware-only solution to server management. By allowing one or more users to access and control multiple servers or other target devices, KVM switches allow a single system administrator to manage many servers, and also save the cost of purchasing a dedicated keyboard, monitor and mouse for each computer, saving space in the server room and limiting cable clutter Further, the elimination of video monitors reduces demands on electric power and cooling systems,

KVM switches often allow “out-of-band” access to servers and other serial devices. As such, they allow users to access, control and manage the company's servers even if the operating system is itself not responsive. A KVM switch with integrated power management can also enable a complete system reboot from a remote location. Typically, such out-of-band access is provided by analog KVM. Analog KVM refers to the analog signals passed from the switch back to the target computer via cable (often coaxial cable or CAT5 cable),

Coaxial cable is a type of relatively inexpensive copper cable which consists of a center wire surrounded by insulation and then a grounded shield of braided wire. Coaxial cable has many disadvantages, including a relatively high level of thickness. This thickness results in great difficulty in installing crowded and complicated cabling solutions in dense server environments, and even limitations in the arrangement of cabling and servers.

CAT5 cable is a kind of unshielded twisted pair or UTP cable. UTP cable comes in a variety of different grades. These grades include Cat5, Cat5E and Cat6, each with increasing bandwidth capabilities. CAT5 cables are thinner than coaxial cables. This allows for much greater ease of installation and a greater freedom in arranging cabling and servers. However, CAT5 cables typically require Interface Modules to connect with the server.

KVM switches typically work in heterogeneous server environments. KVM CAT5 switches themselves are not dependent on the brand of hardware or software of the server. As such, KVM switches can function in environments with servers are from different manufacturers and run on different operating systems. However different severs may different physical ports and logical protocols to receive keyboard and mouse signals, and to transmits video signals. Examples include USB, PS/2, and Sun USB. These formats (physical ports and logical protocols) require a translation mechanism to convert the signals from the KVM switch to the server and back—Interface Modules.

Interface Modules may be referred to as Server Interface Modules (“SIMs”) or Computer Interface Modules (“CiMs”) or any other of a number of names in the KVM industry. These Interface Modules allow a KVM CAT5 switch to interface with heterogeneous set of servers with different physical ports and logical protocols to receive keyboard and mouse signals and transmits video signals. An interface module is connected to the end of a CAT5 cable at one end and to the server KVM ports at the other. The Interface Module will take a signal transmitted from the KVM switch via CAT-5 and translate that signal into the appropriate keyboard and mouse signals as necessary, and further direct such signals either to a USB interface, or a keyboard-mouse pair of PS2 interfaces. The Interface Module will pass video signals back to the KVM switch. The majority of video interfaces used by KVM Interface Modules are a VGA connectors. Other names for a VGA connecter include RGB connector, D-sub 15, mini sub D15 and mini D15. Physically the VGA connecter is a three-row 15 pin DE-15 connecter. The VGA connecter is a “male” connector.

Such Interface Modules may have additional capabilities. One such ability is “Keep Alive”. Some severs will monitor and continue detecting mouse and keyboard signal during their operation. If the signals from the keyboard and mouse are lost, the severs may stop operation, go into a sleep or hibernate mode, cease to transmit video signals, or take other power saving steps. Other programs on the server may also require intermittent keyboard or mouse signals to remain active. The Keep Alive function in an Interface Module “fools” the server into thinking that such a keyboard and mouse are still attached, even when the KVM switch is without power or the CAT5 cable has been disconnected from the KVM switch. The interface module will rely on power from the target server to continue such operation. This Keep Alive ability is useful to keep many different server functions operational.

While allowing the CAT5 KVM to operate in a heterogeneous server environment, such Interface Modules has disadvantages. The Interface Modules increase costs, and also introduce physical thickness near the servers, making the installation of KVM cables for dense server racks such as blade server racks more difficult. Further, providing such Interface Modules increase costs.

To reduce cost, integrated access cables have been introduced into the market which combine the interface module with the CAT5 cable. FIG. 1 shows a prior art integrated access cable 2. The current available integrated access cables combine the interface module 6 in the middle of the CAT5 cable 4, creating a large bulge in the cable. From the integrated interface module, cables connecting to the VGA connector 10 and keyboard mouse connectors 8 of whatever type (PS/2, USB) emerge. While reducing costs, this design retains the problems of thickness and thus cabling installation and arrangement as seen in the the original interface modules not integrated into the cable. Thus, there remains a need in the art for providing the functionality of interface modules with reduced cost, while reducing the thickness introduced by such interface modules.

### BRIEF SUMMARY OF THE INVENTION

One aspect of the present invention includes a KVM system comprising a KVM switch, a target computer, a UTP cable having a first end and a second end, a jack connected to the first end of the UTP cable, an integrated interface connecter having a target end and a switch end, the target end having a video connecter interface and the switch end connected to the second end of the UTP cable, and a keyboard-mouse connecter connected by one or more cables to the switch end of the integrated interface connecter, wherein the integrated interface connecter has an integrated interface module for the translation of keyboard and mouse signals from the KVM switch to the target computer.

### BRIEF DESCRIPTION OF THE DRAWINGS

For a better understanding of the present invention, reference is made to the following description and accompanying drawings, while the scope of the invention is set forth in the appended claims.

FIG. 1 is a schematic diagram of an integrated access cable.

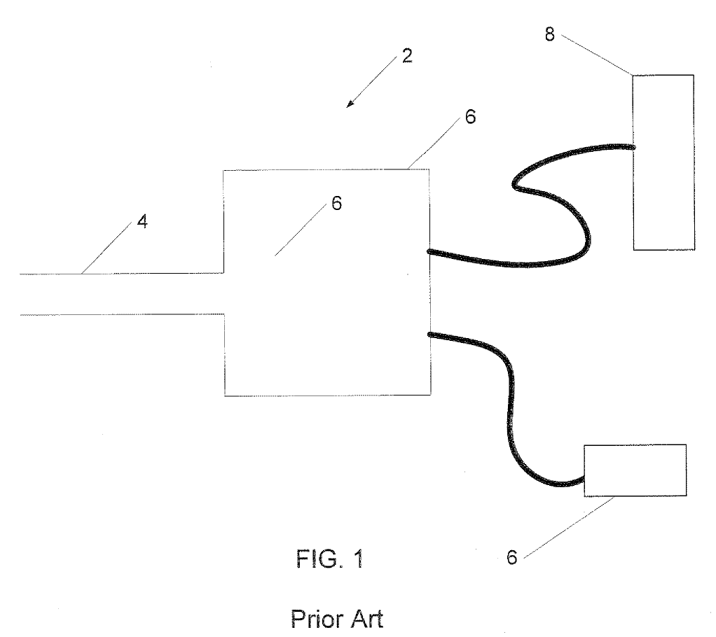

FIG. 2 is a schematic diagram of an improved integrated access cable.

FIG. 3 is a schematic diagram of another improved integrated access cable.

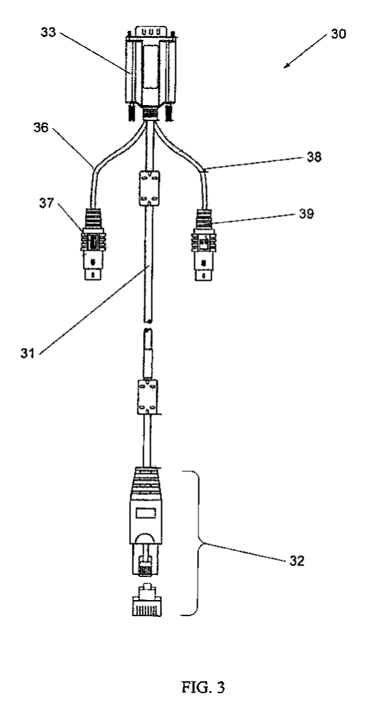

FIG. 4 is a schematic diagram of a PCBA for an improved Integrated Interface Connecter.

FIG. 5 is a schematic diagram of the assembly of an improved Integrated Interface Connecter.

### DETAILED DESCRIPTION OF THE EMBODIMENTS

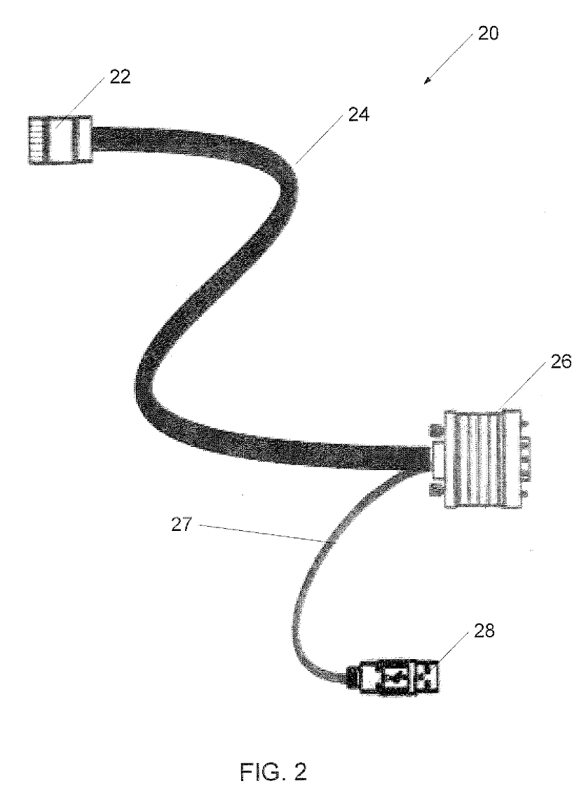

FIG. 2 shows one embodiment of the present invention. An improved integrated access cable 20 has a cable 24 fixably connected at one end to a jack 22, which in turn is removably connected to a KVM switch (not shown). Cable 24 is fixably connected at the other end to Integrated interface Connecter 26. Integrated Interface Connecter 26 is fixably connected to Keyboard-Mouse connector 28 via cable 27. Keyboard-Mouse connector 28 is removably connected to a target server (not shown).

Cable 24 is typically a CAT5E, but may be a variety of cable types, including but not limited to CAT5, CAT5E and CAT6, as well as other specifications as needed. Cable 24 may be of any arbitrary length, limited only by the ability of the cable to carry a signal without substantial degradation.

Jack 22 is typically a 8 Position 8 Contact (8P8C) plug most regularly used as an Ethernet connector. However, any jack capable of connecting cable 24 to a KVM switch may be used as long as the KVM switch has the complementary socket.

Integrated Interface Connecter 26 is in appearance resembles a VGA connector. Integrated Interface Connecter 26 houses the Interface Module hardware, as well as having a 15 pin DE-15 male connecter on one face of its housing,

In the particular embodiment of the present invention shown in FIG. 2, Connecter 28 is USB connector. In a more particular embodiment of the present invention, Connector 28 is a USB Standard-A connector. However, other USE connectors are possible.

In another embodiment of the present invention, an improved integrated access cable 30 has a cable 31 fixably connected at one end to a jack 32 (shown exploded), which in turn is removably connected to a KVM switch (not shown). Cable 31 is fixably connected at the other end to Integrated Interface Connecter 33. Integrated Interface Connecter 33 is fixably connected to Keyboard PS/2 connecter 37 via connector 36. Keyboard PSI2 connecter 37 is removably connected to a PS/2 keyboard port on a computer (not shown). Mouse PSI2 connecter 39 is fixably connected via cable 39 to Integrated Interface Connecter 33. Mouse PS/2 connecter 39 is removably connected to a PS/2 mouse port on a computer (not shown).

Cable 31 is typically a CAT5E, but may be a variety of cable types, including but not limited to CAT5, CAT5E and CAT6, as well as other specifications as needed. Cable 31 may be of any arbitrary length, limited only by the ability of the cable to carry a signal without substantial degradation.

Jack 32 is typically a 8 Position 8 Contact (8P8C) plug most regularly used as an Ethernet connector. However, any jack capable of connecting cable 31 to a KVM switch may be used as long as the KVM switch has the complementary socket.

Integrated Interface Connecter 33 is in appearance resembles a VGA connector. Integrated Interface Connecter 33 houses the Interface Module hardware, as well as having a 15 pin DE-15 male connecter on one face of its housing. KM Connector 28 is a PS/2 mouse connecter and a PS/2 keyboard connecter, each connected to the Integrated Interface Connecter 26 via separate cables.

In yet another embodiment of the present invention, the Integrated Interface Connecter 26 includes the Keep Alive function as is well known in the art.

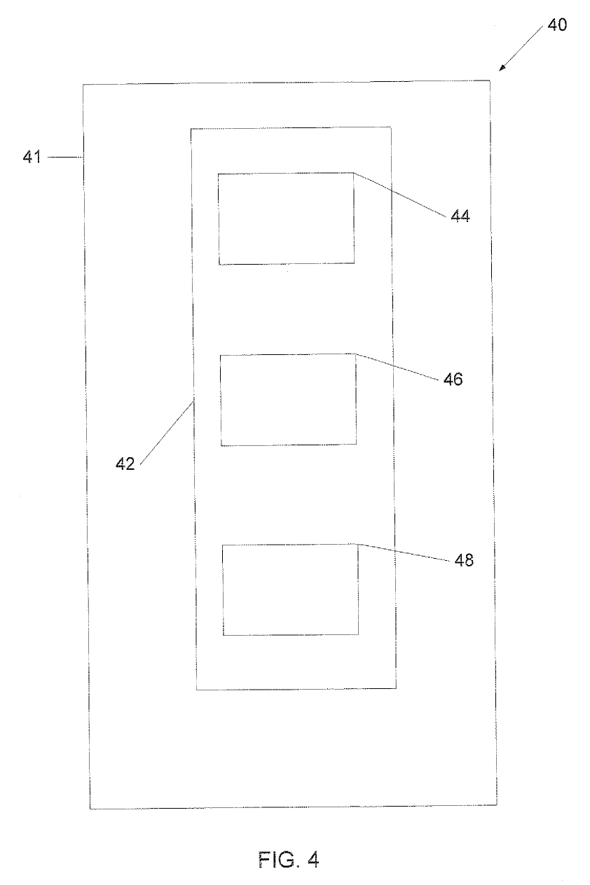

FIG. 4 shows an Integrated Interface Connecter in greater detail. Integrated Interface Connecter 40 is shown having a housing 41. Housing 41 contains ICs 44, 46, and 48 mounted on a Printed Circuit Board Assembly (“PCBA ”) 42. IC 44 is a discrete op amp for driving differential RGB signals over twisted pair cable. IC 46 is a transceiver for handling the physical aspects of information transfer. IC 38 is a microcontroller having a processor, on-board memory, and the capability of driving USE, 12C, and other protocols. IC 48 performs the translation functions of an Interface Module as described above, as well as functions such as the Keep Alive function. These and supporting lCs necessary to complete the PCBA 42 (not shown) are well known to those skilled in the art. The techniques of mounting and connecting the lCs to PCBA 42 and to each other are likewise well known to those skilled in the art

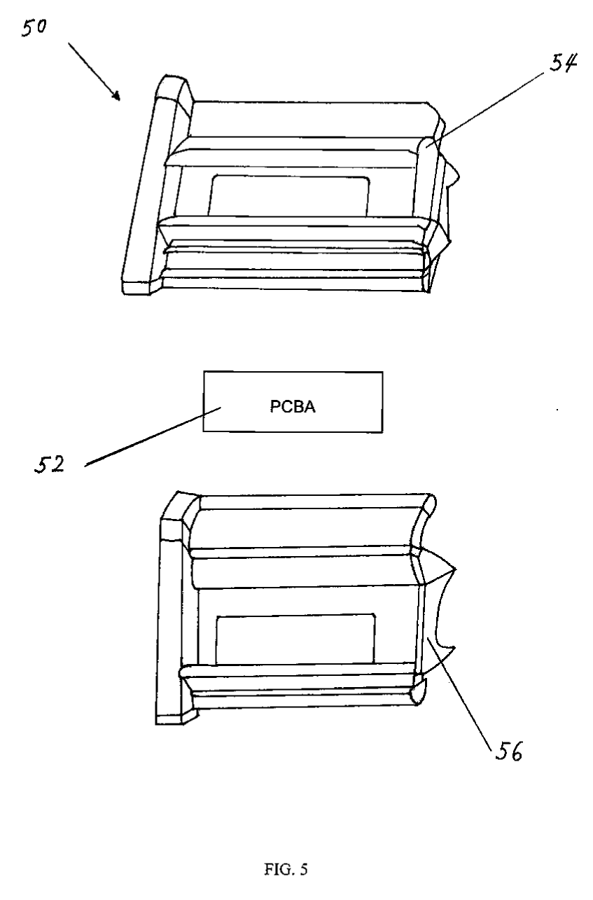

FIG. 5 shows a PCBA 52 embedded inside a the housing of a Integrated Interface Connecter 50. The housing is composed of a top half 54 and a bottom half 56. The housing may be of a number of different material, but is preferably a plastic. In manufacture, the top half 54 and bottom half 56 are compressed together by high pressure press.

One advantage of the present invention is the reduction of thickness along the cable. By placing the Interface Module in a Integrated Interface Connecter in the same housing as the VGA connecter, no bulge and decreased flexibility in the cable hinders the installation and arrangement of cabling for KVM in a rack of servers typical in data centers or other high server density environments. Another advantage of the present invention is the reduction of weight along the cable 24 compared to cable 4 reduces the stress and pull on the connection between the cable and relevant server. This reduces the chances of an integrated access cable pulling out of its connection. Yet another advantage of the present invention is the reduction of distance between the server and the Interface Module functions. This reduces the opportunity for failure by reducing the possibility of cable failure between the server and the interface module.

While the foregoing description and drawings represent the preferred embodiments of the present invention, it will be understood that various changes and modifications may be made without departing from the spirit and scope of the present invention.

What is claimed is:

1. An integrated cable for transmitting Keyboard Video Mouse (KVM) signals from a KVM switch to a target computer comprising:
a) a UTP cable having a first end and a second end;
b) a jack connected to the first end of the UTP cable;
c) an integrated interface connecter having a target end and a switch end; the target end having a video connecter interface and the switch end connected to the second end of the UTP cable, and
d) a keyboard-mouse connecter connected by one or more cables to the switch end of the integrated interface connecter;
e) wherein the integrated interface connecter has an integrated interface module for the translation of keyboard and mouse signals from the KVM switch to the target computer.

2. The integrated cable of claim 1, wherein the UTP cable is a CAT5 cable.

3. The integrated cable of claims 1, wherein the UTP cable is a CAT5E cable.

4. The integrated cable of claims 1, wherein the video connecter interface is a male VGA interface.

5. The integrated cable of claims 1, wherein the keyboard-mouse connecter comprises a USB connecter connected by a single cable to the switch end of the integrated interface connecter.

6. The integrated cable of claims 1, wherein the keyboard-mouse connecter comprises a PS/2 connecter and a keyboard PS/2 connecter each connected by one of two cable to the switch end of the integrated interface connecter.

7. The integrated cable of claims 1, wherein the integrated interface module has a keep alive function for the target computer.

8. A KVM system comprising:
a) a KVM switch;
b) a target computer;
c) a UTP cable having a first end and a second end;
d) a jack connected to the first end of the UTP cable;
e) an integrated Interface connecter having a target end and a switch end; the target end having a video connecter interface and the switch end connected to the second end of the UTP cable; and
f) a keyboard-mouse connecter connected by one or more cables to the switch end of the integrated interface connecter;
g) wherein the integrated interface connecter has an integrated interface module for the translation of keyboard and mouse signals from the KVM switch to the target computer.

9. The integrated cable of claim 8, wherein the UTP cable is a CAT5 cable.

10. The integrated cable of claims 8, wherein the UTP cable is a CAT5E cable.

11. The integrated cable of claims 8, wherein the video connecter interface is a male VGA interface.

12. The integrated cable of claims 8, wherein the keyboard-mouse connecter comprises a USB connecter connected by a single cable to the switch end of the integrated interface connecter.

13. The integrated cable of claims 8, wherein the keyboard-mouse connecter comprises a PSI2 connecter and a keyboard PS/2 connecter each connected by one of two cable to the switch end of the integrated interface connecter.

14. The integrated cable of claims 8, wherein the integrated interface module has a keep alive function for the target computer.
